(19) United States
(12) Patent Application Publication
(10) Pub. No.: US 2014/0085248 A1
(43) Pub. Date: Mar. 27, 2014

(54) DOUBLE HEAD STYLUS HAVING LIGHT POINTER

(71) Applicant: Kuan Yuan Wang, Taipei (TW)

(72) Inventor: Kuan Yuan Wang, Taipei (TW)

(21) Appl. No.: 13/625,879

(22) Filed: Sep. 25, 2012

(51) Int. Cl. G06F 3/033; G06F 3/044

(52) U.S. Cl. 345/174

(57) ABSTRACT

A double head stylus having light pointer includes a tube having a conductive rubber stylus on both ends thereof. A least a conductive portion electrically connected to both the conductive rubber styluses is formed to the tube. Through holding the conductive portion of the tube by hand, both the rubber styluses of the tube are capable of performing capacitive sensing on a capacitive touch panel. One of the conductive rubber styluses has an axial through hole. A light pointer having at least one light source is arranged inside the tube so that the light of the light source will project from the through hole of the conductive rubber stylus as a pointer. A battery and circuit connected between the battery and the light source are arranged inside the tube. A switch serving to control the conductivity between the light source and the battery is arranged to the tube so as to control the operation of the light pointer.

### FIELD OF THE INVENTION

The present invention relates to stylus, and particular to a double head stylus having a light pointer for a touch panel.

### DESCRIPTION OF THE PRIOR ART

Electronic product and its accessory become more and more powerful and convenient such as touch panel and stylus. The use of touch panel and stylus can be found in so many field and application.

A public Taiwan patent of M344519 relates to stylus storage for a PDA (Personal Digital Assistant). The invention mainly includes a magnet within the stylus socket of the device and a magnet inside the stylus. Through the repelling of the magnets, the stylus will be tightly received by the socket. Comparing with prior buckling or magnetic attraction method, it is more consistent and effective.

However, most of the invention about the stylus for touch panel mentions about the storage and improvement for carrying. For the function and application of the stylus, there is still a lot to improve. Prior stylus only has one stylus head to use, it is trouble to locate the end especially while user is in rush or busy. The combination of the stylus with laser pointer or a normal pen will also save a lot of strength and time for the user to carry all kind of instrument in a meeting. Therefore, the inventor of the present invention provide a new application of the stylus which is convenient and innovative for improvement and solving the disadvantage of the prior art.

### SUMMARY OF THE PRESENT INVENTION

Accordingly, the primary object of the present invention is to provide a stylus having stylus head on both ends of the stylus and having function of light pointer. Both ends of the stylus are conductive through a tube of the stylus so that user can use both sides of the stylus to perform input on a touch panel. Preferably, the stylus further has a pen capped by one of the stylus heads so that user can actually use the pen to write.

To achieve above objects, the present invention provides a double head stylus having light pointer including a tube having conductive rubber stylus on both ends thereof. A least a conductive portion electrically connected to both the conductive rubber styluses is formed to the tube. Through holding the conductive portion of the tube by hand, both the rubber styluses of the tube are capable of performing capacitive sensing on a capacitive touch panel.

### BRIEF DESCRIPTION OF THE DRAWINGS

FIG. 1A is a schematic view showing the first embodiment of the present invention.

FIG. 1B is a cross-section view showing the first embodiment of the present invention.

FIG. 2A is a cross-section view showing the second embodiment of the present invention.

FIG. 2B is a cross-section view showing a light pointer of the second embodiment of the present invention.

FIG. 3 is a cross-section view showing the third embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

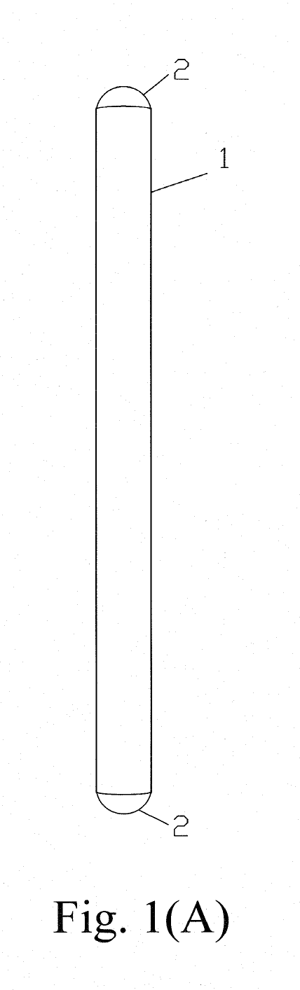

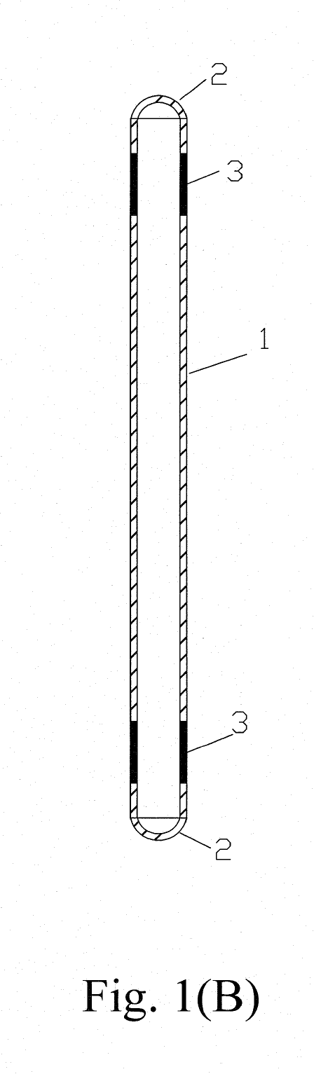

Referring to FIGS. 1 to 3, the preferable embodiment of a double head stylus having light pointer according to the present invention includes the following components.

A tube 1 is a long tubular object having a conductive rubber stylus 2 on both ends thereof. At least one conductive portion 3 is formed to the tube 1. The conductive portion 3 is electrically connected to the two conductive rubber styluses 2. The conductive rubber stylus 2 conducted to the user's hand through the conductive portion 3 can perform a capacitive sensing on a capacitive touch panel.

Each of the conductive rubber styluses 2 of the tube 1 can be used to perform input on a touch panel so that the user don't need to find a specific end for operation.

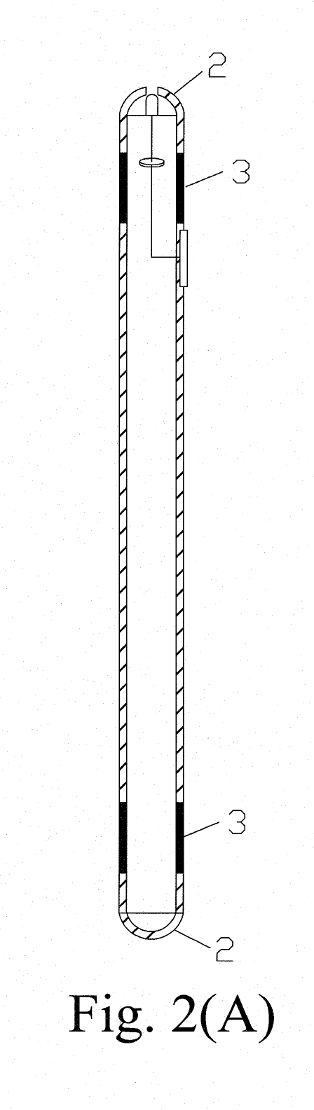

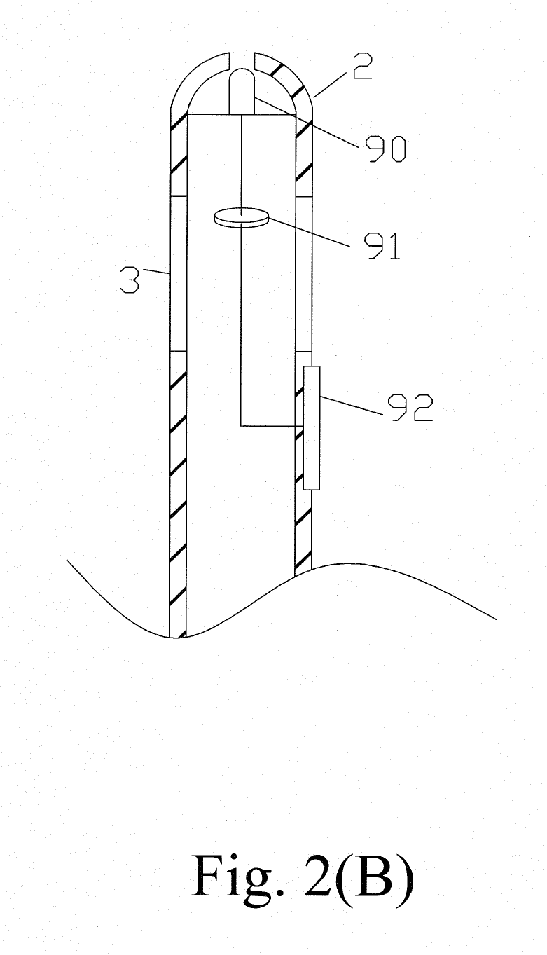

Referring to FIG. 2, the second embodiment of the present invention is illustrated. The double head stylus having light pointer according to the present invention also includes a tube 1 having a conductive rubber stylus 2 on both ends thereof. At least one conductive portion 3 is formed to the tube 1. The conductive portion 3 is electrically connected to the two conductive rubber styluses 2. The conductive rubber stylus 2 conducted to the user' s hand through the conductive portion 3 can perform a capacitive sensing on a capacitive touch panel. An axial through hole 20 is axially formed to the conductive rubber stylus 2.

At least a light source 90 is arranged inside the tube 1 by one of the ends of the tube 1. The light of the light source 90 is projected through the through hole 20 of the conductive rubber stylus 2 as a pointer. The light source is preferably a laser diode or LED.

A battery 91 is arranged inside the tube 1. The battery 91 is electrically connected to the light source 90 through a circuit for supplying power to the light source 90.

A switch 92 is arranged to the tube 1. The switch 92 serves to control the electric connectivity between the battery 91 and the light source 90 so as to control the power supply to the light source 90.

At least one of the two conductive rubber styluses 2 on the two ends of the tube 1 has the through hole 20 and the light source 90 so that the present invention can provide a pointer function which is very convenient to the user.

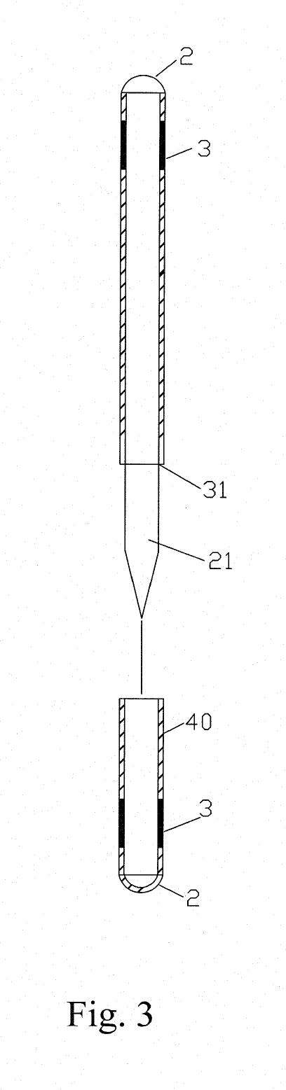

Referring to FIG. 3, the third embodiment of the present invention is illustrated. The embodiment also has two conductive rubber styluses 2 as the first embodiment. The embodiment also includes a tube 10 consisting of a pen 4 and a cap 40.

A conductive rubber stylus 20 and a writing instrument 21 such as a ball pen or a fountain pen are arranged to two ends of the tube 10 respectively. A conductive portion 3 is formed to the tube 10 near the conductive rubber stylus 20. The conductive portion 3 is electrically connected to the conductive rubber stylus 20. The conductive rubber stylus 20 conducted to user's hand through the conductive portion 3 can perform a capacitive sensing on a capacitive touch panel. The tube 10 further has a connection section 31 near to the writing instrument 21.

The cap 40 can be slid onto the writing instrument 21 and connected to the connection section 21. An end of the cap 40 has a conductive rubber stylus 20, and a conductive portion 3 is formed to the cap 40 near the conductive rubber stylus 20. The conductive portion 3 is electrically connected to the conductive rubber stylus 20. The conductive rubber stylus 20 conducted to user' s hand through the conductive portion 3 can perform a capacitive sensing on a capacitive touch panel.

Each of the conductive rubber styluses 20 of the tube 10 and the cap 40 can be used to perform input on a touch panel so that the user don't need to find a specific end for operation. User can also use the writing instrument 21 to write by removing the cap 40.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A double head stylus having light pointer comprising:
a tube having a conductive rubber stylus on two ends thereof; the tube having at least a conductive portion electrically connected to the two conductive rubber styluses; each conductive rubber stylus connected to user' s hand through the conductive portion causing a capacitive sensing on a capacitive touch panel.

2. The double head stylus having light pointer as claimed in claim 1 further comprising:
an axial hole axially formed to one the conductive rubber styluses of the tube;
at least one light source arranged inside the tube near the axial hole of the conductive rubber stylus; the light of the light source being projected ahead through the axial hole as a pointer;
a battery arranged inside the tube; the battery being electrically connected to the light source through a circuit to provide power to the light source;
a switch arranged to the tube; the switch controlling the connectivity between the battery and the light source so as to control the operation of the light source;
wherein the tube has two conductive rubber styluses and at least one light source so as to have both stylus and pointer functions at the same time.

3. The double head stylus having light pointer as claimed in claim 2, wherein the light source is one of a laser diode, LED, or other optic source.

4. A double head stylus having light pointer comprising:
a tube having a pen body and a cap;
the pen body having a conductive rubber stylus and a writing instrument on two ends of the pen body respectively; a conductive portion being formed to the tube near the conductive rubber stylus; the conductive portion being electrically connected to the conductive rubber stylus; the conductive rubber stylus connected to user' s hand through the conductive portion causing a capacitive sensing on a capacitive touch panel;
the cap having a conductive rubber stylus on an end thereof; a conductive portion formed to the cap near the conductive rubber stylus; the conductive portion being electrically connected to the conductive rubber stylus; the conductive rubber stylus connected to user' s hand through the conductive portion causing a capacitive sensing on a capacitive touch panel;
wherein the cap is slid onto the pen body so that the writing instrument is revealed by removing the cap from the pen body to write.

5. The double head stylus having light pointer as claimed in claim 4, wherein the pen body has a connection section for connecting and securing the cap.

6. The double head stylus having light pointer as claimed in claim 4, wherein the writing instrument is one of a ball pen, fountain pen, and a pencil.

7. The double head stylus having light pointer as claimed in claim 4 further comprising:
an axial hole axially formed to the conductive rubber stylus of the pen body;
at least one light source arranged inside the pen body near the axial hole of the conductive rubber stylus; the light of the light source being projected ahead through the axial hole as a pointer;
a battery arranged inside the pen body; the battery being electrically connected to the light source through a circuit to provide power to the light source;
a switch arranged to the pen body; the switch controlling the connectivity between the battery and the light source so as to control the operation of the light source.

8. The double head stylus having light pointer as claimed in claim 4 further comprising:
an axial hole axially formed to the conductive rubber stylus of the cap;
at least one light source arranged inside the cap near the axial hole of the conductive rubber stylus; the light of the light source being projected ahead through the axial hole as a pointer;
a battery arranged inside the cap; the battery being electrically connected to the light source through a circuit to provide power to the light source;
a switch arranged to the cap; the switch controlling the connectivity between the battery and the light source so as to control the operation of the light source.
